(19) United States
(12) Patent Application Publication
(10) Pub. No.: US 2006/0245888 A1
(43) Pub. Date: Nov. 2, 2006

(54) Pipelayer subframe and work machine with same

(76) Inventors: Barry A. Dietz, Wyoming, IL (US); Frederick A. Spiegel III, East Peoria, IL (US); Richard G. Richardson, East Peoria, IL (US); Kenneth J. Hoefling, Kickapoo, IL (US); Jim K. Etzel, Alexis, IL (US); Christopher D. Green, Peoria, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/087,798

(22) Filed: Mar. 23, 2005

(51) Int. Cl. B60P 3/12

(52) U.S. Cl. 414/563

(57) ABSTRACT

In order to reduce production and maintenance costs, it is desirable that application-specific machines, such as pipelayers, include common parts with standard track-type work machines, such as a counterpart bulldozer. According to the present disclosure, a pipelayer is assembled by attaching a winch frame and a boom frame to a first and second side of a chassis, respectively. The attached boom frame and the attached winch frame are interconnected by extending a cross-bar between the boom and winch frames.

### TECHNICAL FIELD

The present disclosure relates generally to tracked type work machines, and more specifically to a frame assembly for a pipelayer.

### BACKGROUND

Pipelayers are unique track-type work machines used specifically in pipelaying operations, in which the pipelayer raises, lowers and carries relatively heavy pipes. Because of the specific application of the pipelayers, there are many components unique to the pipelayer, thereby increasing the cost of production and the number of serviceable parts needed to be stocked. For instance, pipelayers, such as the pipelayer described in U.S. Pat. No. 5,332,110, issued to Forsyth on Jul. 26, 1994, include a tractor chassis attached to right and left track frames. A support frame includes a boom frame that is attached to one side of the chassis and a winch frame that is attached to the other side of the chassis. The boom frame supports a boom which raises, lowers and carries the heavy pipes. The winch frame supports a winch and a counterweight that balances the weight of the pipes being moved by the boom. The winch frame and the boom frame are attached to one another via a center frame that is also attached to the chassis. The position of the center frame on the chassis can interfere with installation of tractor components, such as an engine, into a standard-sized tractor chassis during assembly. Thus, in order to assemble the pipelayer, a longer, modified chassis, along with modified tractor components, are used, thereby increasing the cost of production. Moreover, the center frame attached to the chassis can obscure the field of vision for the pipelayer operator.

In order to reduce the cost of production of pipelayers, it has been known to convert a used standard bulldozer tractor chassis, with installed tractor components, into a pipelayer. However, performance, can be compromised with a converted bulldozer/pipelayer. For instance, the tracks of a standard bulldozer are generally shorter than the tracks of a pipelayer in the same weight class. The shorter tracks of the bulldozer can reduce the for and aft stability of the pipelayer. If the pipelayer is laying pipe in a trench that extends uphill or when the pipelayer is being loaded onto a truck, the converted pipelayer may be more likely to tip than a pipelayer with the longer tracks. The longer tracks also reduce ground pressure, which enables a pipelayer to work better in muddy conditions. Pipelayers also generally perform better with a hard bar track frame attachment to the chassis, whereas the bulldozers generally include a pivot bar that allows the two tracks to pivot relative to each other and the frame, as illustrated in the bulldozer/pipelayer combination set forth in U.S. Pat. No. 6,609,622 B2, issued to Forsyth on Aug. 26, 2003.

The present disclosure is directed at overcoming one or more of the above problems.

### SUMMARY OF THE INVENTION

In one aspect of the present disclosure, a track type work machine includes a work machine chassis. A first sub-frame and a second sub-frame are attached to a first side and a second side of the chassis, respectively. A cross-bar interconnects the first and second sub-frames and is unattached to the chassis.

In another aspect of the present disclosure, a pipelayer sub-frame includes a sub-frame body that includes a cross-bar attachment portion and a rigid arched portion that extends between at least one chassis attachment and at least one track frame attachment.

In yet another aspect of the present disclosure, a pipelayer is assembled by attaching a boom frame to a first side of a chassis and a winch frame to a second side of a chassis. The attached boom frame and the attached winch frame are interconnected by extending a cross-bar between the attached boom frame and the attached winch frame.

### BRIEF DESCRIPTION OF THE DRAWINGS

FIG. 1 is a front isometric view of a pipelayer, according to the present disclosure;

FIG. 2 is a partial, see-through isometric view of a winch frame and a boom frame attached to a chassis of the pipelayer of FIG. 1;

FIG. 3 is a front view of the winch frame and the boom frame attached to the chassis of the pipelayer of FIG. 1; and

FIG. 4 is a bottom view of an offset hard bar attached to the chassis and a track frame of the pipelayer of FIG. 1.

### DETAILED DESCRIPTION

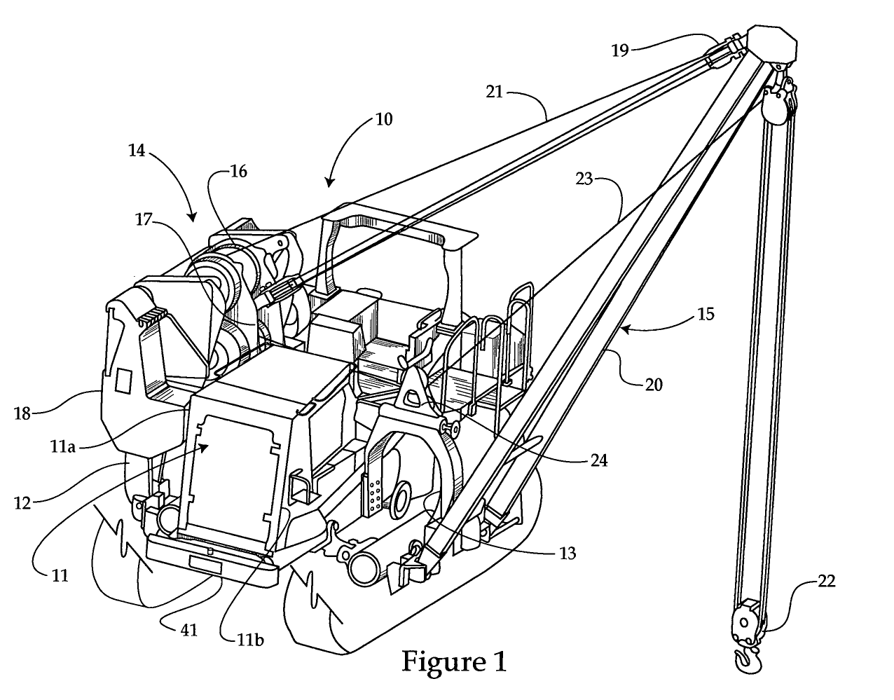

Referring to FIG. 1, there is shown a pipelayer 10, according to the present disclosure. Although the present disclosure is illustrated for the pipelayer 10, it should be appreciated that the present disclosure could apply to various track type work machines to which an implement or a portion of an implement is attached to opposite sides of the work machine. The pipelayer 10 includes a work machine chassis 11 including a first side 11a and a second side 11b. The chassis 11 is preferably a standard-bulldozer chassis 11. A first sub-frame, preferably a winch frame 12, is attached to the first side 11a of the chassis 11, and a second sub-frame, preferably a boom frame 13, is attached to a second side 11b of the chassis 11. Those skilled in the art will appreciate that the winch frame 12 also includes a counterweight frame. A conventional boom assembly 15 of the type known in the art is attached to the boom frame 13, and a counterweight 18 and a winch assembly 14 of the type known in the art is attached to the winch frame 12. Those skilled in the art will appreciate that the winch assembly 14 includes a boom winch 16, and a load winch 17. The boom winch 16 is coupled to a boom block 19 of a boom 20 via a boom cable 21 such that rotation of the boom winch 16 in one direction causes the boom 20 to lower and rotation in the other direction causes the boom 20 to raise. Similarly, the load winch 17 is coupled to a load hook block 22 via a load cable 23 that is routed around a load sheave 24 such that the rotation of the load winch 17 in one direction causes the load hook block 22 with an attached load hook to lower and rotation in the other direction causes the load hook block 22 to be raised. Thus, the boom and load winches 16 and 17 are used to lift, position and lower a load, such as a pipe, attached to the load hook. It should also be appreciated that the counterweight 18 can be moved in order to compensate for the position and load on the boom 20. A bumper 41 of the type known in the art used specifically for pipelayers is attached to a front of the chassis 11.

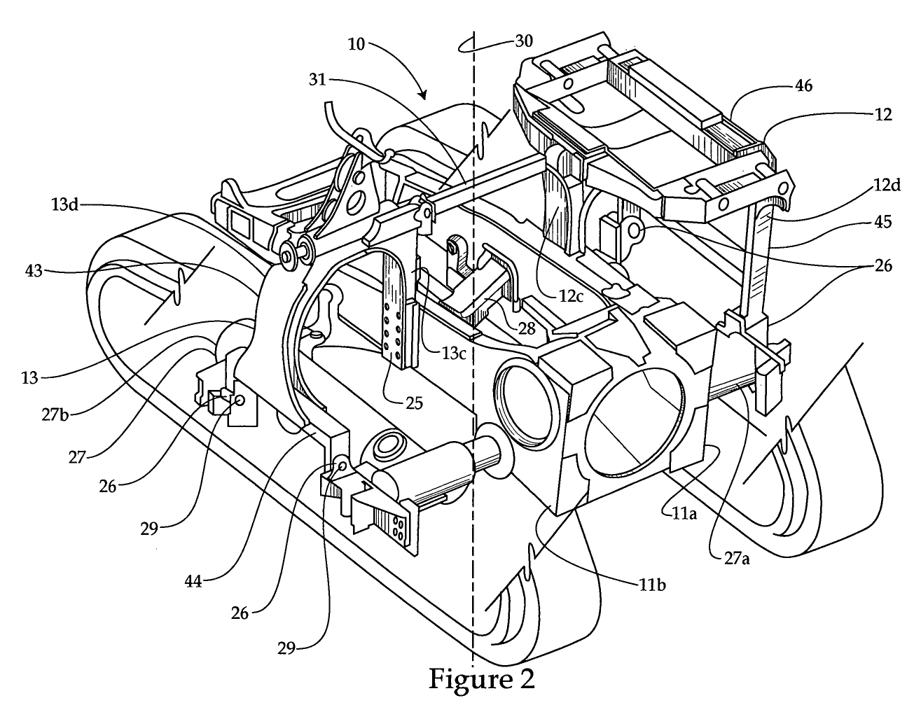

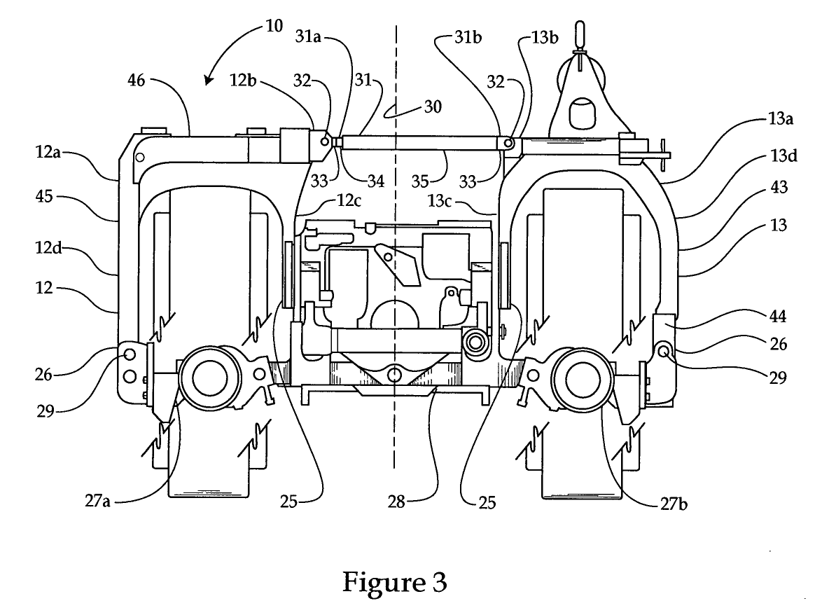

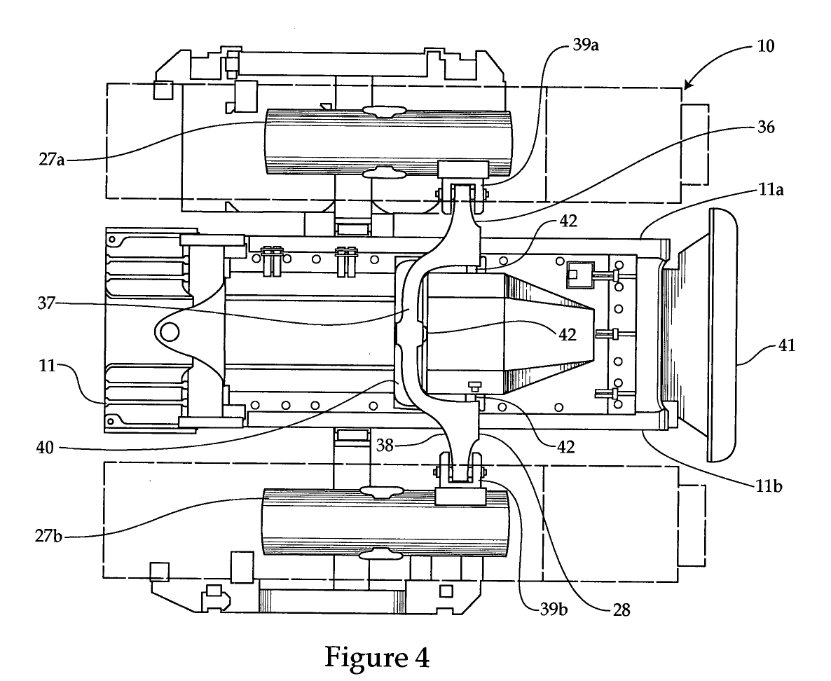

Referring to FIG. 2, there is shown a partial see-through isometric view of the winch frame 12 and the boom frame 13 attached to the chassis 12 of the pipelayer 10. The pipelayer 10 is shown without the boom assembly 15 and the winch assembly 14 for clarity. The pipelayer 10 includes a first track frame 27a and a second track frame 27b attached to the first and second sides 11a and 11b of the chassis 11, respectively, via an offset hard bar 28 (shown in FIGS. 3 and 4). A pair of endless tracks are attached to each track frame 27a and 27b. It should be appreciated that the track frames 27a and 27b are preferably relatively long track frames of the type known in the art and used with pipelayers. In other words, track frames 27a & b are longer than a track frame for a bulldozer of the same class that would be attached to chassis 11, if the work machine were to be a standard bulldozer. Both the winch frame 12 and the boom frame 13 include a chassis attachment 25 and two track frame attachments 26. Although the present disclosure is illustrated including only one chassis attachment 25 and two track frame attachments 26 for each sub-frame 12 and 13, it should be appreciated that the present disclosure contemplates any number of chassis attachments and track frame attachments. Preferably, each chassis attachment 25 includes a plurality of bolts extending into a bolt plate that is welded to the chassis or preferably part of the chassis 11. Each track attachment 26 includes a pin 29 that is orientated in a horizontal line perpendicular to a vertical axis 30 extending through the chassis 11. Those skilled in the art will appreciate that the pins 29 extend through a bore defined by mating portions of the frames 12 and 13 and the track frames 27a and 27b. It should be appreciated that the present disclosure contemplates some, or all, the pins being parallel to the vertical axis 30. Moreover, the present disclosure contemplates the winch and boom frames 12 and 13 also being attached to the chassis 11 via pins. Pins 29 are relatively easy to manufacture, which can result in reduced production and assembly costs.

Referring to FIG. 3, there is shown a front view of the boom frame 13 and the winch frame 12 attached to the chassis 11 of the pipelayer 10. The pipelayer 10 is shown without the boom assembly 15 and the winch assembly 14 for clarity. Although the winch frame 12 and the boom frame 13 are shaped differently in order to support the different weight and shape of the winch assembly 14 and boom assembly 15, both the winch frame 12 and boom frame 13 include a rigid arched portion 12a and 13a, respectively, extending between the chassis attachment 25 and two track frame attachments 26 (only one attachment 26 per frame 12 and 13 shown in FIG. 3). It should be appreciated that, for purposes of this discussion, the term rigid means that no section of the arched portion 12a or 13a can move with respect to another section of the same arched portion 12a or 13a. Thus, the arched portion 12a and 13a is either one frame piece or consists of multiple frame pieces fixedly attached to one another by means such as welding or bolting. In the illustrated embodiment, the rigid arched portions 12a and 13a of both the winch frame 12 and the boom frame 13 include an inner chassis portion 12c and 13c and an outer track portion 12d and 13d. As shown in FIG. 2, the outer track portion 13d of the boom frame 13 includes one support bar 43 connected to the track frame attachments 26 via a connection bar 44, and the outer track portion 12d of the winch frame 12 includes two support bars 45, each connecting one track frame attachment 26 to a winch support 46. However, those skilled in the art will appreciate that the design of the rigid arched portions can vary.

The pipelayer 10 includes a cross-bar 31 that interconnects the boom frame 13 and the winch frame 12, but cross-bar 31 is unattached to the chassis 11. Preferably, the cross-bar 31 is detachable from both the winch and boom frames 12 and 13. For instance, in the present disclosure, the cross-bar 31 is attached to a cross-bar attachment portion 12b and 13b of winch and boom frame 12 and 13 by pins 32. Thus, the cross-bar 31 can be detached from the winch and boom frames 12 and 13 by removing the pins 32. However, the present disclosure contemplates the cross-bar being permanently attached to the cross-bar attachment portions by conventional means, such as welding the cross-bar to the winch and boom frames. The cross-bar 31 includes a tube 35 with a rod eye 33 attached to a first end 31a and a second end 31b of the cross bar 31. Each rod eye 33 mates with the attachment portions 12b and 13b of the frames 12 and 13, and the pins 32 extend through the rod eyes 33 and attachment portions 12b and 13b. At least one of the rod eyes 33 screws into a threaded insert 34 welded into the end of the tube 35 and allows for adjustment of the length of the cross-bar 31. The cross-bar 31 helps distribute the weight of the load between the winch frame 12 and the boom frame 13. It should be appreciated that the size of the cross-bar 31 can vary among pipelayers of different sizes. It should be appreciated that the cross-bar 31 could be positioned at various locations extending between the winch frame 12 and the boom frame 13 that does not interfere with the operator's visibility and the installation and servicing of the tractor components. In fact, the cross-bar could alternatively be extended between the winch assembly and the load sheave attached to the top of the boom frame. The cross-bar could also extend directly between the boom assembly and the winch assembly.

Referring to FIG. 4, there is shown a bottom view of the pipelayer 10 of FIG. 1. The offset hard bar 28 attaches the first and second track frames 27a and 27b to the first and second sides 11a and 11b of the chassis 11, respectively. The offset hard bar 28 is illustrated as attached to a bottom surface of the chassis 11 at multiple attachment points 42. This prevents bar 28 from pivoting as in a conventional bulldozer. The offset hard bar 28 includes a first frame attachment portion 36, a center portion 37 and a second track frame attachment portion 38. The center portion 37 is positioned within cross-member support cavity 40 which is strategically positioned within the bottom surface of the chassis 11 in order to avoid essential tractor components, such as the engine. Those skilled in the art will appreciate that a cross member support is a standard tractor component. The center portion 37 is offset from the first and second frame attachment portions 36 and 38. The first frame attachment portion 36 and the second frame attachment portion 38 attach to offset hard bar attachments 39a and 39b on each track frame 27a and 27b, respectively. The attachments 39a and 39b should be fixed such that there is no rotation of the offset hard bar 28. Although the attachments 39a and 39b are illustrated as fixed by including pins that are orientated in a plane perpendicular to the vertical axis 30, it should be appreciated that the ends of the offset hard bar could be welded or bolted to the offset hard bar attachments. By offsetting the center portion of the offset hard bar 28, a longer pipelayer track frame can be used with the standard sized chassis 11. More specifically, longer track frames will generally include offset hard bar attachments at different point than standard track frames. (shown with the dotted lines) Rather than moving the cross-member support cavity 40 on the chassis 11 or the offset hard bar attachments 39a and 39b on the track frames 27a and 27b, the offset hard bar 28 is offset. Thus, the longer track frames generally preferred for pipelayers can be attached to standard sized track-type chassis without interfering with essential components, such as the engine. However, those skilled in the art will appreciate that the a conventional straight offset hard bar (shown in shadow) could be used and the cross-member support attachments 39a and 39b of the track frames 27a and 27b could be adjusted to be aligned with the cross-member support cavity 40.

### INDUSTRIAL APPLICABILITY

Referring to FIGS. 1-4, a method of assembling the pipelayer 10 will be discussed. Preferably, the first and second track frames 27a and 27b are attached to the first and second side 11a and 11b of the chassis 11 by extending the offset hard bar 28 between the chassis 11 and the first and second track frames 27a and 27b. The offset hard bar 28 is positioned within the cross-member support cavity 40 of the chassis 11 such that the first attachment portion 36 of the bar 28 can be attached to the offset hard bar attachment 39a on the first track frame 27a and the second attachment portion 38 can be attached to the offset hard bar attachment 39b of the second track frame 27b. The offset hard bar 28 is attached to the attachments 39a and 39b of the frames 27a and 27b with pins. The pins are orientated in a plane that is perpendicular to the vertical axis 30 extending through the chassis 11. The offset hard bar 28 can be fixedly pinned to the offset hard bar attachments 39a and 39b by various methods known in the art. However, those skilled in the art should also appreciate that the offset hard bar 28 could be fixedly attached to the track frames 39a and 39b in a manner different than pinning, including, but not limited to, welding the attachment portions of the offset hard bar to the attachments of the track frames. Moreover, the center portion 37 of the offset hard bar 28 is securely attached at multiple attachment points 42 to the underside of the chassis 11 such that the offset hard bar 28 cannot rotate. Because the cross-member support cavity 40 is out of alignment with the offset hard bar attachments 39a and 39b of the track frames 27a and 27b, attaching the track frames 27a and 27b to the chassis 11 is accomplished by offsetting the center portion 37 of the offset hard bar 28 from the first and second attachment portions 36 and 38. By offsetting the center portion 37, relatively long track frames 27a and 27b can be attached to the standard-sized chassis 11 even with the cross-member support cavity 40 positioned for shorter track frames. The longer track frames 27a and 27b can provide more stability to the pipelayer 10 when working on the side of a hill or being loaded onto and off of a moving truck. Thus, rather than making costly modifications to the chassis 11 or the track frames 27a and 27b, the offset hard bar 28 is offset.

The winch frame 12 and the boom frame 13 are attached the first side 11a and the second side 11b of the chassis 11, respectively. The rigid arched portion 13a of the boom frame 13 is preferably positioned over the second endless track supported by the second track frame 27b. The boom frame 13 is attached to the chassis 11 via the chassis attachment 25, which includes bolts. The two track frame attachments 26 include pins 29 oriented in a plane perpendicular to the vertical axis 30. The boom frame 13 can be bolted to the chassis 11 and pinned to track frame 27b by any conventional means known in the art. Those skilled in the art will appreciate that the boom frame 13 could be attached to the chassis 11 and the track frame 27b via any fixed attachment, including, but not limited to, welds, at various attachment points. The arched shape of the boom frame 13 can help support the boom assembly 15.

The winch frame 12 is attached similarly to the boom frame 12 in that the rigid arch portion 12a of the winch frame 12 is positioned over the first endless track supported first track frame 27a. The winch frame 12 is attached to the first side 11a of the chassis 11 via the chassis attachment 25, and is attached to the track frame 27a via two track frame attachments 26. The chassis attachment 25 includes bolts, and the track frame attachments 26 include pins 29 that are oriented in a plane perpendicular to the vertical axis 30, although those skilled in the art will appreciate that the winch frame 12 could be attached to the chassis 11 and the track frame 27a with any fixed attachment, including, but not limited to, welds. The arch shape of the winch frame 13 can help support the winch assembly 15.

The attached boom frame 13 and the attached winch frame 12 are interconnected by extending the cross-bar 31 between the attached boom frame 13 and attached winch frame 12. The first end 31a of the cross-bar 31 is pinned to the winch frame 12 and the second end 31b of the cross-bar 31 is pinned to the boom frame 13. The pins 32 extend through the attachment portions 12b and 13b of the boom and winch frames 13 and 12 and the rod eyes 33 on each end 31a and 31b of the cross-bar 31. Before attaching the cross-bar 31 to the frames 12 and 13, the rod eye 33 within the treated insert 34 of the cross-bar 31 can be twisted in one direction to extend the length of the cross-bar 31 or in the other direction to shorten the cross-bar 31. Thus, the length of the cross-bar 31 can be adjusted in order to fit between frames attached to chassises with various widths. The cross-bar 31 is preferably detachable from the boom frame 13 and the winch frame 12. By interconnecting the boom frame 13 and the winch frame 12, the weight of the load can be distributed equally between the frames 13 and 12, thus avoiding premature wear or failure on one of the frames 12 or 13. The winch assembly 14 and the boom assembly 15 can be attached to the winch frame 12 and the boom frame 13, respectively.

The present disclosure is advantageous because it provides a pipelayer 10 that includes the standard-sized track-type bulldozer chassis 11 to which the pipelayer components can be attached without compromising the performance of the pipelayer 10. In the present disclosure, the boom frame 13 is separate from the winch frame 12, and only interconnected by the detachable cross-bar 31. The cross-bar 31 is relatively small and can be removed in order not to interfere with the installation of the tractor components, such as the operator station. Because the support frame does not interfere with the installation of the tractor components, a longer chassis to compensate for the center frame and the installation of tractor components is not needed. Moreover, the cross-bar 31 distributes the load between the boom and winch frame 12 and 13 in order to avoid premature wear or failure. Thus, the support frame can still provide support to the boom and winch assemblies 14 and 15 while the standard sized track-type chassis 11 and many standard tractor components can be used.

Similarly, the present disclosure is advantageous because the pipelayer 10 includes the standard-sized track-type chassis 11 attached to relatively long pipelayer track frames 27a and 27b supporting the endless tracks. The relatively long tracks balance the pipelayer 10 as it works at a slanted angle, such as laying pipe up the side of a hill or driving onto a truck for transportation. The offset hard bar attachments 39a and 39b the longer track frames 27a and 27b advantageous to pipelayers are at a different position than the attachments of the shorter track frames. Instead of making costly modifications to the chassis 11 or the track frames 27a and 27b, the offset hard bar 28 extending between the track frames 27a and 27b and the chassis 11 is offset. Moreover, the offset hard bar 28 is fixedly attached to the track frames 27a and 27b rather than allowed to oscillate as it does with some other types of track-type work machines, such as bulldozers. Thus, the longer tracks advantageous to the pipelayer 10 can be used with the standard tractor-type chassis 11.

By attaching specialized pipelayer parts, such as the longer tracks and the boom and winch frames, to the standard track-type bulldozer chassis, the number of specialized components used on the pipelayer 10 and the cost of production of the pipelayer 10 are reduced. For instance, the number of serviceable parts that must be stocked is reduced because the pipelayer 10 has more parts in common with other standard track-type work machines, such as counterpart bulldozers. Further, the present disclosure is advantageous because by replacing the center frame with the detachable cross-bar 31, the operator's visibility is increased.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A track type work machine comprising:
a work machine chassis;
a first sub-frame attached to a first side of the chassis;
a second sub-frame attached to a second side of the chassis; and
a cross-bar interconnecting the first and second sub-frames and being unattached to the chassis.

2. The work machine of claim 1 including a first track frame and a second track frame being attached to the first and second side of the chassis, respectively, via an offset hard bar; and
the offset hard bar including a first track frame attachment portion, a center portion and a second frame attachment portion, and the center portion being offset from the first and second track frame attachment portions.

3. The work machine of claim 1 wherein the cross-bar being detachable.

4. The work machine of claim 1 wherein the work machine includes a pipelayer, the first sub-frame includes a winch frame and the second sub-frame includes a boom frame.

5. The work machine of claim 4 wherein a winch assembly being attached to the winch frame and a boom assembly being attached to the boom frame.

6. The work machine of claim 4 wherein the winch frame and the boom frame each include at least one chassis attachment and at least one track frame attachment.

7. The work machine of claim 6 wherein the winch frame and the boom frame each include a rigid arched portion extending between the at least one chassis attachment and the at least one track frame attachment.

8. The work machine of claim 7 wherein the at least one chassis attachment includes a plurality of bolts, and the at least one track frame attachment each includes a pin.

9. The work machine of claim 8 wherein the pin being orientated in a plane perpendicular to a vertical axis extending through chassis.

10. The work machine of claim 9 wherein the cross-bar being detachable;
a first track frame and a second track frame being attached to the first and second side of the chassis, respectively, via an offset hard bar including a first track frame attachment portion, a center portion and a second frame attachment portion, and the center portion being offset from the first and second track frame attachment portions; and
a winch assembly being attached to the winch frame and a boom assembly being attached to the boom frame.

11. A pipelayer sub-frame comprising:
a sub-frame body including a cross-bar attachment portion and a rigid arched portion extending between at least one chassis attachment and at least one track frame attachment.

12. The pipelayer sub-frame of claim 11 wherein the cross-bar attachment includes a detachable cross-bar attachment portion.

13. The pipelayer sub-frame of claim 11 wherein the sub-frame body including at least one of a winch and boom sub-frame body.

14. The pipelayer sub-frame of claim 13 wherein the winch frame and the boom frame each include at one chassis attachment and two track frame attachments.

15. The pipelayer sub-frame of claim 14 wherein the cross-bar attachment portion includes a detachable cross-bar attachment portion.

16. A method of assembling a pipelayer, comprising the steps of:
attaching a winch frame to a first side of a chassis;
attaching a boom frame to a second side of a chassis; and
interconnecting the attached boom frame to the attached winch frame, at least in part, by extending a cross-bar between the attached boom frame and the attached winch frame.

17. The method of claim 16 wherein the step of interconnecting includes a step of pinning a first end and a second end of the cross-bar to the boom frame and the winch frame, respectively.

18. The method of claim 16 including a step of attaching a first and second track frames to the chassis, at least in part, by extending an offset hard bar between the chassis and the first and second track frames, and offsetting a center portion of the offset hard bar from track attachment portions of the offset hard bar.
